(19) United States
(12) Patent Application Publication
(10) Pub. No.: US 2013/0189532 A1
(43) Pub. Date: Jul. 25, 2013

(54) ADHESIVE COMPOSITIONS

(71) Applicants: Henkel Corporation, Rocky Hill, CT (US); Henkel AG & Co. KGaA, Duesseldorf (DE)

(72) Inventors: Chiu-Sing Lin, Rocky Hill, CT (US); Alfred A. DeCato, Waterbury, CT (US); Shingo Tsuno, Kanagawa (JP); Kiyotaka Sawa, Ichihara-City (JP)

(73) Assignees: Henkel AG & Co. KGaA, Duesseldorf, DE (US); Henkel Corporation, Rocky Hill, CT (US)

(21) Appl. No.: 13/796,482

(22) Filed: Mar. 12, 2013

Related U.S. Application Data
(63) Continuation of application No. PCT/US2012/031941, filed on Apr. 3, 2012.
(60) Provisional application No. 61/479,427, filed on Apr. 27, 2011.

(51) Int. Cl. C08L 33/04; B32B 27/30; B32B 7/12

(52) U.S. Cl. CPC C08L 33/04; B32B 7/12; B32B 27/308
USPC 428/448; 526/279; 524/255; 524/158; 524/425; 524/547; 428/704

(57) ABSTRACT

Moisture curable poly(acrylate) compositions having more environmentally acceptable catalysts and/or faster skin over time. The compositions demonstrate resistance to hydrocarbon fluids, such as transmission fluids, oils and fuels and are useful as gasketing materials.

### FIELD

This specification provides curable poly(acrylate) compositions. In one embodiment the compositions use catalysts which are more environmentally acceptable than previous curable poly(acrylate) compositions. In one embodiment the compositions provide faster skin over time than previous poly(acrylate) compositions. Cured reaction products of these compositions are useful as gasketing materials for use with hydrocarbon fluids, such as transmission fluids.

### BRIEF DESCRIPTION OF RELATED TECHNOLOGY

Poly(acrylate) compositions have excellent sealing and adhesive properties, and have many commercial uses. For instance, they can be formed into gaskets which are used extensively in the automotive industry.

However, conventional poly(acrylate) compositions use dibutyltin dilaurate catalysts which are effective catalysts but are undesirable in some locations such as Europe. Conventional poly(acrylate) compositions also cure more slowly than desired and can take 60 minutes or more for the surface of a conventional poly(acrylate) gasket bead applied to a sealing surface to “skin over”. Before the gasket bead has skinned over the composition remains tacky and the sealing surface can not be exposed to fluids without risk that the applied sealant will wash out allowing leakage. Thus, assembled components such as internal combustion engines must be stored until the composition has skinned over before pressure testing with oil can be conducted, slowing productivity and requiring storage facilities where the hundreds of parts can remain until the poly(acrylate) gasket composition has skinned over. The faster the skin over time the faster assembled components can be processed and the less storage space is needed.

Accordingly, it would be desirable to provide poly(acrylate) compositions useful for gasketing applications that do not use dibutyltin dilaurate as a catalyst. It would be desirable to provide poly(acrylate) compositions that provide faster skin over time than previous poly(acrylate) compositions.

### SUMMARY

In one embodiment moisture curable poly(acrylate) compositions are provided which do not use dibutyltin dilaurate as a catalyst. This embodiment can use a dual catalyst system comprising a non-dibutyltin metal moisture cure catalyst in combination with an amine-based moisture cure catalyst. The dual catalyst system provides the disclosed poly(acrylate) compositions with through cure characteristics similar to conventional poly(acrylate) compositions using dibutyltin dilaurate.

In one embodiment moisture curable poly(acrylate) compositions including selected skin enhancing additives are provided which have a skin over time of about 45 minutes or less and preferably about 30 minutes.

In one embodiment moisture curable poly(acrylate) compositions are provided which do not use dibutyltin dilaurate as a catalyst, but do comprise a dual catalyst system comprising a metal moisture cure catalyst in combination with an amine-based moisture cure catalyst and a skin enhancing additive.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure and understanding the concept and embodiments disclosed herein, a person of ordinary skill can, without inventive effort, explore beyond the disclosed limits and, when embodiments are found to be without any unexpected characteristics, those embodiments are within the meaning of the term about as used herein.

### DETAILED DESCRIPTION

In one embodiment there is provided a composition comprising a silyl-functionalized poly(acrylate) component and a combination of metal comprising and amine comprising moisture cure catalysts. This composition has a surprising combination of long storage life and quick curing after application to a surface, properties that are opposing in nature. In another embodiment there is provided a composition comprising a silyl-functionalized poly(acrylate) component and a skin enhancing additive component. This composition provides a surprisingly short skin over time compared to conventional poly(acrylate) compositions. The compositions can include one or more other additives such as filler, a plasticizer, a diluent, an anti-oxidant, a component which reduces shrinkage of the cured composition when exposed to hydrocarbon fluids, an adhesion promoter, a thixotrope, a colorant, a moisture scavenger and/or an odor mask to better suit the composition for selected applications.

Silyl-functionalization of the poly(acrylate) component may be in the form of a pendant group or a terminal (or, end-capped) group. In some embodiments, the poly(acrylate) component may be an alkyl acrylate polymer, such as an alkyl (meth)acrylate polymer. For purposes of this disclosure, the term “(meth)acrylate” includes acrylates and methacrylates.

More specifically, the backbone of the silyl-functionalized poly(acrylate) component may include a homopolymer of C₁-C₁₀ (meth)acrylates or a copolymer of C₁-C₁₀ (meth)acrylates. Suitable alkyl acrylates include, but are not limited to, ethyl acrylate, butyl acrylate and 2-ethylhexyl acrylate. Copolymeric acrylate backbones may contain copolymerized units of up to 40% by weight of monovinyl monomers, for example, styrene, acrylonitrile, vinylbutyl ether, acrylic acid and C₁-C₁₀ alkyl acrylates different from the principal alkyl acrylate comonomer. Such copolymers are available commercially, for example, as HYTEMPS acrylate rubbers (acrylic homopolymer and copolymer rubbers available from Nippon Zeon, KK) and TOACRON AR-601 acrylate rubbers (polyethylacrylate polymers, available from Toa Paint, KK).

In other embodiments the poly(acrylate) component may be a polyfunctional (meth)acrylate polymer. Such polymers may have a high degree of functionality due to the presence of multiple functional groups in the main chain of the polymer.

Certain alkyl acrylate polymers are described more fully in U.S. Pat. No. 6,506,460 to Paglia et al, which is expressly incorporated by reference herein in its entirety.

The silyl-functionalized poly(acrylate) component used in the present composition may be of the following structure:

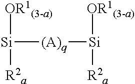

where a is integer from 0-1, q is an integer from 2 to about 1,000, and A is a hydrocarbon diradical containing at least one (meth)acrylate linkage. Desirably, a is 1 or 2. R² in each occurrence may be the same or different and is a C₁ to C₂₀ hydrocarbon radical. In a desirable aspect, R² is C₁ to C₆ alkyl. More desirably, R² is C₁ to C₃ alkyl.

R¹ in each occurrence may be the same or different. Substituent R¹, in combination with the oxygen to which it is attached, forms a hydrolyzable group, which provides the compositions of this disclosure with their ability to undergo room temperature vulcanization (“RTV”). RTV cure typically occurs through exposure of the compositions to moisture such as humidity. The presence of hydrolyzable moisture curing groups, such as alkoxy groups, on the silicon atom permits the compositions to crosslink. Suitable —O—R¹ hydrolyzable groups include alkoxy groups such as methoxy, ethoxy, propoxy, and butoxy; aryl groups such as phenoxy; acyloxy groups such as acetoxy; aryloxy groups such as phenoxy; and alkoxyalkyl groups such as CH₃OCH₂CH₂—. Larger groups such as propoxy and butoxy are slower to react than smaller groups such as methoxy and ethoxy. Accordingly, the rate at which the compositions undergo moisture cure can be influenced by choosing appropriately sized groups for substituent R¹. Desirably, R¹ is a C₁ to C₁₀ hydrocarbon radical. More desirably R¹ is C₁ to C₄ alkyl, for example methyl or ethyl.

Unless otherwise defined, the term “hydrocarbon radical” is intended to refer to radicals which are primarily composed of carbon and hydrogen atoms. Thus, the term encompasses aliphatic groups such as alkyl, alkenyl, and alkynyl groups; aromatic groups such as phenyl; and alicyclic groups, such as cycloalkyl and cycloalkenyl. The term “hydrocarbon diradical” is intended to refer to the corresponding divalent radicals of these groups.

Kaneka Telechelic Polyacrylate OR100S sold by Kaneka Corporation is exemplary of this type of silyl-functionalized poly(acrylate) component.

The backbone of the poly(acrylate) component may be multifunctional, thereby imparting a higher degree of functionality to the polymer than the alkyl(meth)acrylate polymers described above. The monomer used to form the backbone of the polymer is not particularly restricted but a variety of monomers may be selectively employed. Suitable examples include, but are not limited to, (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, and the like. These monomers may be used each alone or a plurality of them may be copolymerized.

The poly(acrylate) component may have a molecular weight distribution, i.e., the ratio of weight average molecular weight to number average molecular weight as determined by gel permeation chromatography, of less than 1.8, preferably not more than 1.7, more preferably not more than 1.6, still more preferably not more than 1.5, particularly not more than 1.4, and most preferably not more than 1.3.

In one embodiment the poly(acrylate) composition cures only by exposure to moisture such as humidity in the air. Such compositions require a moisture curing catalyst to enhance and control the cure speed. Dibutyltin dilaurate is effective as a moisture cure catalyst for poly(acrylate) compositions and may be used where use of that catalyst is not objectionable. Dibutyltin dilaurate catalysts may be employed in an amount sufficient to promote moisture cure, which generally is from about 0.05% to about 5% by weight, and advantageously from about 0.1% to about 1% by weight of the composition.

However, the use of dibutyltin dilaurate containing compositions can be undesirable in certain areas such as Europe. Thus, some embodiments of the present compositions avoid use of any dibutyltin dilaurate.

Replacement of dibutyltin dilaurate with another catalyst is not a straightforward matter. Curable compositions must not cure for long periods of time when stored in a sealed state (e.g. have a long storage life) but must rapidly cure through its entire depth when applied as a bead to a sealing surface (e.g. have a quick cure through the entire cross section of the applied sealant bead). Balancing these contrary requirements is difficult. For example, a moisture curable silyl-functionalized poly(acrylate) composition made by replacing dibutyltin dilaurate with the same amount of chemically similar dioctyltin dilaurate has acceptable storage life but cures more slowly than desirable for commercial use. Adding a second catalyst can speed curing of the moisture curable silyl-functionalized poly(acrylate) composition during application. However, moisture curable silyl-functionalized poly(acrylate) composition using dual catalyst systems can uncontrollably cure in an undesirably short time after manufacture even when sealed, providing such compositions with an unacceptably short storage life for many commercial applications.

Surprisingly, use of an amine-based catalyst package together with a metal moisture cure catalyst allows an acceptable, commercially useful balance of cure speed and storage life. Suitable metal moisture cure catalysts for these embodiments include compounds which contain such metals as titanium, tin, or zirconium. Illustrative examples of titanium compounds include tetraisopropoxy titanate and tetrabutoxy titanate. Illustrative examples of the tin compounds include dibutyltin bis-(2-ethylhexyl maleate), dioctyltin dineodecanoate, dibutyltin dilauryl mercaptide, dioctyltin dilauryl mercaptide, dibutyltin diacetyl acetonate, dibutyltin bis-(1-thioglycerol), dioctyltin diacetate, dibutyltin diacetate, dioctyltin dilaurate, dioctyltin dicarboxylate, dimethyltin dicarboxylate, and dibutyltin dioctoate. Illustrative examples of the zirconium compounds include zirconium octanoate. Dioctyltin dilaurate is presently preferred.

Suitable amine moisture cure catalysts for these embodiments include 1,8-diazabicyclo[5.4.0]undec-7-ene (“DBU”), tetramethylguanidine (“TMG”), and 1,5-diazabicyclo[4.3.0]non-5-ene (“DBN”). Tetramethylguanidine is presently preferred.

The metal and amine-based moisture cure catalysts are employed in an amount sufficient to provide a desirable balance of cure speed and storage life. Generally, the metal moisture cure catalysts are used in amounts from about 0.05% to about 1.0% by weight, and advantageously from about 0.5% to about 0.9% by weight of the composition in combination with amine-based moisture cure catalysts used in amounts from about 0.2% to about 0.6% by weight, and advantageously from about 0.3% to about 0.5% by weight of the composition.

Skin over time (SOT) is the time it takes for the surface of a bead of moisture curable poly(acrylate) composition to become dry to the touch or non-tacky, although the interior of the bead remains uncured. Skin over time is different then cure time, which is the time required for the full thickness of the applied composition to cure. Conventional moisture curable poly(acrylate) compositions using dibutyltin dilaurate typically have skin over times of 60 minutes or more. Using a second catalyst system can affect cure time and undesirably shorten storage life but will not have a substantial effect on skin over time. Surprisingly, adding small amounts of one or more selected skin enhancing additives can substantially shorten skin over time without negatively impacting storage life. These skin enhancing additives are believed to accelerate bonding of functional end groups of the poly(acrylate) component. Some useful skin enhancing additives include diphenyldimethoxysilane, phenyltrimethoxysilane, vinyltrimethoxysilane, methyltrimethoxysilane and ethyltrimethoxysilane.

The skin enhancing additive component should be included in an amount sufficient to speed skin over time without deleteriously affecting other desired properties of the composition. Skin enhancing additive amounts within the range of about 0.1% to about 1.0% by weight of curable composition, desirably about 0.25% to about 0.7% by weight of curable composition are currently useful to shorten skin over time.

In some embodiments the curable poly(acrylate) composition can include a diluent to adjust viscosity of the composition. Some useful diluents can have the following structure:

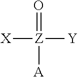

where Z is S or P, X and Y may be the same or different and may be hydroxy, alkyl, alkenyl, aryl, aralkyl, aralkenyl, alkoxy, alkenoxy and aryloxy and A is ═O, or alkoxy, alkenoxy or aryloxy.

Desirable diluents within this structure are sulfonates and phosphates. For instance, alkyl sulfonic acid esters, such as methyl sulfonic acid methyl ester or aryl sulfonic acid esters, such as phenol- and/or cresol-pentadecane sulfonates, like phenyl 1-pentadecane sulfonates are desirable. And triphenyl phosphates, such as tricresyl phosphates, are useful.

The diluent should be included in an amount within the range of about 0.5% to about 25% by weight of curable composition, such as about 2.5% to about 14% by weight of curable composition, desirably about 5% to about 13% by weight of curable composition.

In some embodiments the curable poly(acrylate) composition can include an anti-oxidant to lessen hardening of the cured composition upon exposure to heat and improve working life of a gasket formed by the cured composition. The anti-oxidant is either a phenylene diamine compound, such as one within structure I:

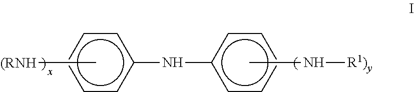

where R and R¹ are each members individually selected from C₁₋₁₂ alkyl, C₂₋₁₂ alkenyl, C₃₋₁₂ cyclo or bicycloalkyl, C₆₋₁₈ aryl, and derivatives thereof, and x and y are each individually 0-2, or a diphenyl amine compound, such as one within structure II:

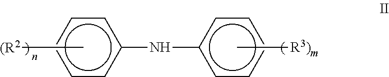

where R² and R³ are each members individually selected from C₁₋₁₂ alkyl, C₂₋₁₂ alkenyl, C₃₋₁₂ cyclo or bicycloalkyl, C₆₋₁₈ aryl, and derivatives thereof, and n and m are each individually 0-5. Combinations of the phenylene diamine and diphenyl amine compounds can be surprisingly more effective than the same amount of phenylene diamine compound or diphenyl amine compound used separately.

Within structure I are phenylene diamines commercially available from Chemtura Corporation, Middlebury, Conn. (under the FLEXZONE or NAUGARD trade names), R.T. Vanderbilt Company, Inc., Norwalk, Conn. (under the AGERITE or VANOX trade names), Flexsys America, Akron, Ohio (under the SANTOFLEX trade name), or Sumitomo Chemical Company Ltd., Osaka, Japan (under the SUMILIZER trade name), such as

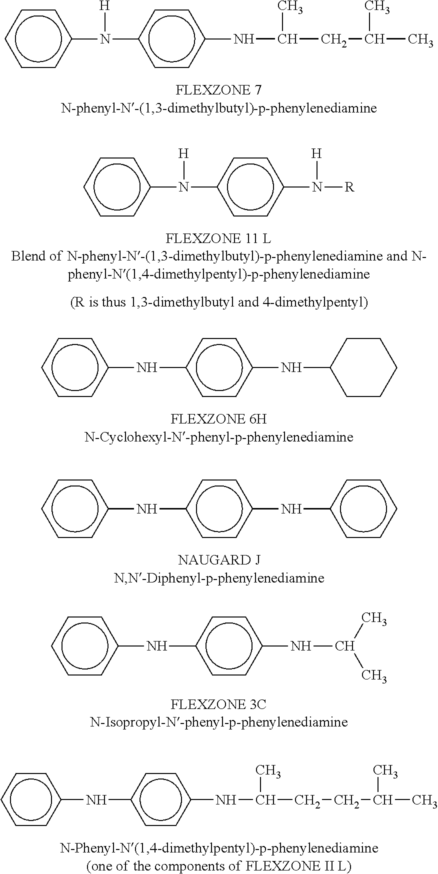

Vanderbilt offers many of such products under the trade names AGERITE (such as DPPD, HIPAR T HP-S, NEPA, STALITE, STALITES, SUPERFLEX, WHITE, and WHITE WHITE) and VANOX (such as 12).

Sumitomo offers for sale many of these compound types under the SUMILIZER trade name, such as BPA, BPA-M1, 41, 4M and 9A.

Within structure II, commercially available examples include those from Chemtura (under the NAUGARD trade name), such as:

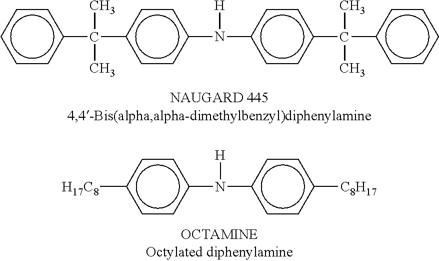

The phenylene diamine compound and/or diphenyl amine compound should be used in an amount of about 0.05 to about 10% by weight, such as about 0.5 to about 3% by weight, of the composition.

In some embodiments the curable poly(acrylate) composition can include an additive to reduce shrinkage of the cured composition when exposed to a hydrocarbon fluid. If present, the component can be used in an amount of about 1% to about 20% by weight of the composition. Desirably, the component should be present in an amount of about 1% to about 10% by weight of the composition.

The component may be a polyolefin in particulate form, a reactive liquid, or a combination thereof. In one aspect, the polyolefin powder is comprised of a polyolefin containing repeating units of at least one C₂ to C₇ alkylene monomer.

In an advantageous aspect, the polyolefin is a particulate in powder form. The polyolefin powder will generally have an average particle size of about 0.1 to about 50 microns. Desirably, the polyolefin powder has an average particle size of about 20 microns. Polyolefin powders suitable for use in the disclosed compositions typically have a melting point in the range from about 75° C. to about 175° C. When the compositions have reached a temperature above the melting point of the polyolefin powder used therein, the polyolefin powder will typically be substantially dissolved in the composition. A commercially available family of polyolefin powder suitable for this use are those sold under the trade name MICROTHENE by Equistar Chemical Company, with average densities ranging from 0.909 to 0.952 g/cc. Desirably, the polyolefin powder is MICROTHENE FN 51000.

In some embodiments the curable poly(acrylate) composition can include one or more silane compounds which act as adhesion promoters. These silane compounds may be present in amounts of about 0.1% to about 5.0% by weight of the composition. Desirably, these compounds are present in amounts of about 0.5% to about 2% by weight of the composition. Silane compounds which are useful in the composition include, but are not limited to, amino-containing silane compounds containing amino-alkyl groups, such as gamma-ureidopropyltrimethoxy silane, 3-aminopropyl trimethoxysilane, N,N′-bis(3-trimethoxy silylpropyl)urea, gamma-aminopropyltrimethoxysilane, N-(2-aminoethyl)-3-aminopropyltriethoxysilane, N-(2-aminoethyl)-3-aminopropyltrimethoxysilane, trimethoxysilylpropyldiethylene triamine, tertiary alkyl carbamate silane, and aminoethyl-3-aminopropyl-methyl-dimethylsilane. Other desirable amino-containing silane compounds include silane compounds containing amino-cycloaliphatic groups such as methyl tris(cyclohexylamino)silane and silane compounds containing amino-aromatic groups, such as methyl tris-(N-methylbenzamido)silane.

Examples of other useful commercially available adhesion promoters include octyl trimethoxysilane (commercially available from Chemtura under the trade designation A-137), glycidyl trimethoxysilane (commercially available from Chemtura under the trade designation A-187), methacryloxypropyl trimethoxysilane (commercially available from Chemtura under the trade designation of A-174), vinyl trimethoxysilane, tetraethoxysilane and its partial condensation products, and combinations thereof.

In some embodiments the curable poly(acrylate) composition can include the presence of a polymeric matrix in amounts of about 2.5% to about 20%, for instance about 5% to about 15%, such as about 7% to about 10%, by weight of the total composition. When present in these amounts, the non-flowability characteristics of a composition can be obtained with minimal undesirable effects, such as loss of substantial tensile properties or sealing characteristics. Additionally, these materials can be added directly in solid form, such as in powder or particulate form, without pre-melting of the particles.

The polymeric matrix includes an organic material, which generally has a melting point or softening point range in the range of about 200° F. (93° C.) to about 500° F. (260° C.), more desirably greater than 250° F. (121° C.) to about 500° F. (260° C.). Polymeric materials useful in the present composition may be selected for instance from polyamides, polyacrylamides, polyimides, polyhydroxyalkylacrylates, urea-urethanes, hydroxy or amine modified aliphatic hydrocarbons (such as castor oil-based rheological additives), liquid polyester-amide-based rheological additives and combinations thereof. Of particular utility are polyamide materials having a melting point of about 260° F. (127° C.). One such polyamide is commercially available as a non-reactive free flowing powder under the trade name DISPARLON, such as 6100, 6200 or 6500, from King Industries Specialties Company, Norwalk, Conn. The recommended use in accordance with commercially available data sheets for DISPARLON 6200 is for epoxy adhesive and potting compounds in amounts of about 0.5% to about 3% by weight; the recommended use in accordance with commercially available data sheets for DISPARLON 6500 is for epoxy adhesive and potting compounds in amounts of about 0.5% to about 3% by weight.

The polyamide materials desirably have a particle size less than about 15 microns, although other particle sizes are useful. The melting or softening point of the polymeric matrix materials ranges from about 200° F. (93° C.) to about 500° F. (260° C.). In a particularly desirable embodiment, a polyamide having a melting point of about 250° F.-270° F. (121° C.-132° C.) and desirably about 260° F. (127° C.) is employed.

Commercially available examples of hydroxyl or amine modified aliphatic hydrocarbons and liquid polyester-amide based rheological additives include THIXCIN R, THIXCIN GR, THIXATROL ST and THIXATROL GST from Rheox Inc., Hightstown, N.J. These modified aliphatic hydrocarbons are castor oil based materials. The hydroxyl modified aliphatic hydrocarbons are partially dehydrated castor oil or partially dehydrated glycerides of 12-hydrostearic acid. These hydrocarbons may be further modified with polyamides to form polyamides of hydroxyl stearic acid are described as being useful polyamides. Liquid polyester-amide based rheological additives include THIXATROL TSR, THIXATROL SR and THIXATROL VF rheological additives available from Rheox Inc., Hightstown, N.J. These rheological additives are described to be reaction products polycarboxylic acids, polyamines, alkoxylated polyols and capping agents. Useful polycarboxylic acids include sebacic acid, poly(butadiene) dioic acids, dodecane dicarboxylic acid and the like.

In some embodiments the moisture curable poly(acrylate) composition can include one or more fillers. Useful fillers include oxides such as silica in particulate or fumed form and carbonates such as calcium carbonate. Fillers can be present in the composition at, for example, an amount from about 5 to about 60% by weight of the total composition. Desirably, the filler is present in an amount from about 20 to about 40% by weight of the composition.

The moisture curable poly(acrylate) composition can include other additives so long as they do not inhibit the curing mechanism, elongation, or intended use. For example, conventional additives such pigments, moisture scavengers, inhibitors, odor masks, and the like may be included. Moisture scavengers such as methyltrimethoxysilane and vinyltrimethyloxysilane are also useful in the present composition.

Gaskets are used to seal against the ingress and egress of materials, for instance environmental or other elements or contaminants into a chamber or to prevent fluid leakage from the chamber. In the context of an automotive power train, their function is extremely important to the performance of the engine, transmission, differential, etc.

There are many types of gasketing materials, and liquid polymeric sealants make up a significant part of the market. These liquid polymeric sealants gaskets fall into two main categories: (1) form-in-place gaskets and (2) cure-in-place gaskets. Form-in-place gaskets rely on adhesion to both substrates for maintaining the seal between the substrates. On the other hand, cure-in-place gaskets are applied in liquid form to one substrate, then cured to a solid with heat, or photoirradiation, such as with UV and/or visible light. The second substrate may then be placed there over. Cure-in-place gaskets therefore operate as compression gaskets. The present compositions are specially suited for use as form-in-place gaskets as the faster SOT allows the sealed substrates to be exposed to liquids as soon as the composition is skinned over and before fully cured.

The composition can be used to form a gasket, the method including the steps of:

providing a composition in accordance with the present disclosure;

disposing the composition on a first preselected sealing surface;

overlying a second preselected sealing surface on the disposed composition; and

permitting the disposed composition to skin over.

The method can include the further steps of exposing the disposed composition to conditions and for a time sufficient to fully cure the composition and/or exposing the composition to a hydrocarbon fluid.

The compositions may also be formed into many different configurations before curing. These articles may be used in various industries where there is a need for oil resistant elastomeric articles. In the vehicular assembly industry, for example, discrete O-rings, seals, and gaskets can be formed from the present compositions. Other conventional uses requiring good adhesive properties, as well as oil-shrinkage resistance, are also contemplated for the compositions.

In another aspect, there is provided a method of applying a composition to a preselected sealing surface that is exposed to oil during its intended use. The preselected surface to which the present compositions are applied can be any surface that is exposed to oil, such as sealing surfaces of internal combustion engines and transmissions. Some illustrative surfaces include the cylinder head to valve cover surfaces, the engine block to oil pan surfaces, the engine block to timing cover surfaces and the transmission housing to transmission pan surfaces. This method includes applying a composition of the present disclosure to the preselected surface. The work surface may be constructed of a variety of materials, such as most metals, glass, and commodity or engineered plastics.

The following examples are included for purposes of illustration so that the disclosure may be more readily understood and are in no way intended to limit the scope of the disclosure unless otherwise specifically indicated.

### EXAMPLES

The following test procedures were used.

| | |
|---|---|
| Hardness | ASTM D2240 |
| Tensile strength | ASTM D412 |
| elongation | ASTM D412 |
| Aluminum lap shear adhesive strength | ASTM D1002 |
| joint movement | ASTM D1002 |

Skin over time is tested by disposing a small amount of test material onto a surface. The material is gently contacted with the tip of a stainless steel spatula. If material transfers from the test material to the spatula tip it has not skinned over. Testing is continued until test material does not transfer to the spatula tip when contacted. This is recorded as the skin over time.

A typical procedure for preparing these formulations is as follows:

A mixer can be charged with the silyl-functionalized poly(acrylate) and if used, diluent and/or antioxidant can be mixed into the silyl-functionalized poly(acrylate). While gradually heating the mixture to a temperature of about 100° C., fillers, pigments and shrinkage reducing component, if used, can be added to the mixer. The mixture can be stirred at high speed under vacuum at a temperature of about 110° C. for a period of time of about 2 hours. The mixture can be cooled to a temperature of about 55° to 60° C., and the mixture can be stirred under vacuum for a period of time of about 10 minutes. The mixture can then be further cooled (about 20° to 50° C.), at which point additives, adhesion promoters and catalysts can be added under nitrogen, and the mixture can be stirred for a period of about 10 to 30 minutes. Subsequently the mixture can be placed under vacuum and stirred for about 10 to 30 minutes while cooling. The sample is subsequently packed into sealed containers for further use.

A silyl-functionalized poly(acrylate) composition using the following materials (Comparative Example A) was prepared using the procedure set out above. All percentages are rounded and by weight percent of the silyl-functionalized poly(acrylate) composition.

Comparative Example A

| material | wt % |
|---|---|
| silyl-functionalized poly(acrylate)component¹ | 41 |
| fillers² | 33 |
| Alkylsulfonic acid phenyl ester³ | 14 |
| polyolefin⁴ | 3 |
| antioxidants⁵ | 2 |
| thixotrope⁶ | 2 |
| catalysts⁷ | 2 |
| adhesion promoter⁸ | 1 |
| skin enhancing additive⁹ | 1 |

¹OR110S from Kaneka Corporation
²CaCO3
³MESAMOLL L235, Bayer Corporation
⁴MICROTHENE, Equistar Chemical Company
⁵1 wt % SANTOFLEX 134PD and 1 wt % NAUGARD 445
⁶DISPARLON 6500
⁷dibutyltin dilaurate
⁸aminopropyltrimethoxysilane
⁹vinyltrimethoxysilane

Comparative Example A had an initial skin over time of >60 minutes despite use of 2 wt % dibutyltin dilaurate catalyst and 1 wt % vinyltrimethoxysilane.

A silyl-functionalized poly(acrylate) composition using the following materials (Example 1) was prepared using the procedure set out above. All percentages are rounded and by weight percent of the silyl-functionalized poly(acrylate) composition.

Example 1

| material | wt % |
|---|---|
| silyl-functionalized poly(acrylate)component¹ | 44 |
| fillers² | 32 |
| Alkylsulfonic acid phenyl ester³ | 14 |
| polyolefin⁴ | 3 |
| antioxidants⁵ | 2 |
| thixotrope⁶ | 2 |
| catalysts⁷ | 1 |
| adhesion promoter⁸ | 1 |
| skin enhancing additive⁹ | 1 |

¹OR110S from Kaneka Corporation
²CaCO3 and fumed SiO2
³MESAMOLL L235, Bayer Corporation
⁴MICROTHENE, Equistar Chemical Company
⁵1 wt % SANTOFLEX 134PD and 1 wt % NAUGARD 445
⁶DISPARLON 6500
⁷0.4 wt % dioctyltin dilaurate and 0.7 wt % tetramethylguanidine
⁸aminopropyltrimethoxysilane
⁹diphenyldimethoxysilane and vinyltrimethoxysilane

In Example 1, adding a small amount of diphenyldimethoxysilane had an initial skin over time of about 32 minutes.

A sample of the Example 1 material was cured in a 25° C. chamber with 55±5% relative humidity for one week. The cured material was tested for cured physical properties. Results from a cured sample of conventional moisture curable silyl-functionalized poly(acrylate) composition are included for comparison.

TABLE 1
cured material properties

| property | conventional B¹ | Example 1 |
|---|---|---|
| Hardness (Shore A) ASTMD2240 | 26 | 25 |
| Tensile strength (psi)ASTM D412 | 184 | 189 |
| elongation (%) ASTM D412 | 206 | 263 |
| Aluminum lap shear adhesive strength | 170 | 167 |
| (psi) ASTM D1002 | | |
| joint movement (inch) ASTM D1002 | 0.14 | 0.14 |

¹5810 moisture curable poly(acrylate), Henkel Corporation, CT

Cured samples were aged in hot air for 3 weeks and 6 weeks. Results are shown in the following Table.

TABLE 2
hot air aged properties

| | conventional B¹ | Example 1 |
|---|---|---|
| property | initial/3 wks/6 wks | initial/3 wks/6 wks |
| aging temp (° C.) | 150 | 150 |
| Hardness (Shore A) | 26/37/37 | 25/48/54 |
| Tensile strength (MPa) | 1.27/2.64/3.12 | 1.27/2.49/2.90 |
| elongation (%) | 206/142/135 | 240/163/141 |
| Aluminum lap shear | 1.17/2.46/2.70 | 1.15/2.93/2.88 |
| adhesive strength (MPa) | | |
| joint movement² (inch) | 0.14/0.11/0.10 | 0.15/0.14/0.12 |

¹5810 moisture curable poly(acrylate), Henkel Corporation, CT
²all failures were cohesive.

Cured samples were aged in engine oil at 150° C. for 3 weeks and 6 weeks. Results are shown in the following Table.

TABLE 3
hot engine oil aged properties

| | conventional B¹ | Example 1 |
|---|---|---|
| property | initial/3 wks/6 wks | initial/3 wks/6 wks |
| aging temp (° C.) | 150 | 150 |
| Hardness (Shore A) | 26/40/41 | 25/45/46 |
| Tensile strength (psi) | 184/347/364 | 189/409/426 |
| elongation (%) | 206/101/84 | 263/123/98 |
| Aluminum lap shear | 170/439/490 | 167/463/641 |
| adhesive strength (psi) | | |
| joint movement (inch) | 0.14/0.10/0.10 | 0.14/0.10/0.09 |

¹5810 moisture curable poly(acrylate), Henkel Corporation, CT

Cured samples were aged in DEXRON VI automatic transmission fluid at 150° C. for 3 weeks and 6 weeks. Results are shown in the following Table.

TABLE 4
hot ATF aged properties

| | conventional B¹ | Example 1 |
|---|---|---|
| property | initial/3 wks/6 wks | initial/3 wks/6 wks |
| aging temp (° C.) | 150 | 150 |
| Hardness (Shore A) | 26/34/38 | 25/44/45 |
| Tensile strength (psi) | 184/325/318 | 189/370/347 |
| elongation (%) | 206/115/82 | 263/112/100 |
| Aluminum lap shear | 170/424/540 | 167/528/616 |
| adhesive strength (psi) | | |
| joint movement (inch) | 0.14/0.09/0.09 | 0.14/0.09/0.09 |

¹5810 moisture curable poly(acrylate), Henkel Corporation, CT

Cured samples were air aged in sealed containers at 50° C. Samples were periodically tested for extrusion rate (grams/minute) and skin over time (minutes). Results are shown in the following Table.

TABLE 5
SOT and extrusion rate

| | property | | | |
|---|---|---|---|---|
| | conventional B¹ | | Example 1 | |
| | aging temp (° C.) | | | |
| | 50 | | 50 | |
| | extrusion | | extrusion | |
| | rate (g/min) | SOT (min) | rate (g/min) | SOT (min) |
| initial | 43 | about 90 | 48 | 32 |
| 1 week | 30 | about 90 | 35 | 32 |
| 2 weeks | 20 | about 90 | 29 | 32 |
| 3 weeks | 19 | about 90 | 25 | 32 |
| 4 weeks | —² | about 90 | 20 | 34 |

¹5810 moisture curable poly(acrylate), Henkel Corporation, CT
²not measured

As shown by the extrusion rate results the Example 1 composition had a storage life as good as or better than conventional Example B. The material of Example 1 had, and maintained through storage, a much faster skin over time than conventional Example B.

A silyl-functionalized poly(acrylate) composition using the following materials (Example 2) was prepared using the procedure set out above. All percentages are rounded and by weight percent of total curable composition.

Example 2

| material | wt % |
|---|---|
| silyl-functionalized poly(acrylate)component¹ | 44 |
| fillers² | 30.5 |
| Alkylsulfonic acid phenol and cresol esters | 15 |
| polyolefin⁴ | 3 |
| antioxidants⁵ | 2 |
| thixotrope⁶ | 2 |
| catalysts⁷ | 0.8 |
| adhesion promoter⁸ | 1.1 |
| skin enhancing additive⁹ | 1.0 |

¹OR110S from Kaneka Corporation
²CaCO3 and fumed SiO2
³MESAMOLL L235, Bayer Corporation
⁴MICROTHENE, Equistar Chemical Company
⁵1 wt % NAUGARD 445 and 1 wt % SANTOFLEX 134PD
⁶DISPARLON 6500
⁷dibutyltin dilaurate
⁸aminopropyl trimethoxysilanes
⁹diphenyldimethoxysilane and vinyl trimethoxysilane

Example 2 with diphenyldimethoxysilane as a skin enhancing additive had a skin over time of about 35 minutes. The same composition without the diphenyldimethoxysilane had a skin over time of about 90 minutes. The addition of a small amount of diphenyldimethoxysilane surprisingly improves skin over time as compared to the 60 to 90 minutes required by conventional poly(acrylate) materials.

A silyl-functionalized poly(acrylate) composition using the following materials (Example 3) was prepared using the procedure set out above. All percentages are rounded and by weight percent of total curable composition.

Example 3

| material | wt % |
|---|---|
| silyl-functionalized poly(acrylate)component¹ | 44 |
| fillers² | 30.5 |
| Alkylsulfonic acid phenol and cresol esters | 15.4 |
| polyolefin⁴ | 3 |
| antioxidants⁵ | 2 |
| thixotrope⁶ | 2 |
| catalysts⁷ | 0.5 |
| adhesion promoter⁸ | 1.1 |
| skin enhancing additive⁹ | 1.0 |

¹OR110S from Kaneka Corporation
²CaCO3 and fumed SiO2
³MESAMOLL L235, Bayer Corporation
⁴MICROTHENE, Equistar Chemical Company
⁵1 wt % NAUGARD 445 and 1 wt % SANTOFLEX 134PD
⁶DISPARLON 6500
⁷dibutyltin dilaurate
⁸aminopropyl trimethoxysilanes
⁹0.5 wt % phenyltrimethoxysilane and 0.5 wt % vinyl trimethoxysilane

Example 3, using phenyltrimethoxysilane and vinyl trimethoxysilane as skin enhancing additives had a skin over time of about 38 minutes. The addition of a small amount of phenyltrimethoxysilane surprisingly improves skin over time.

A comparative silyl-functionalized poly(acrylate) composition using the following materials (Comparative Example C) was prepared using the procedure set out above. All percentages are rounded and by weight percent of total curable composition.

Comparative Example C

| material | wt % |
|---|---|
| silyl-functionalized poly(acrylate)component¹ | 44 |
| fillers² | 31 |
| Alkylsulfonic acid phenol and cresol esters | 15.2 |
| polyolefin⁴ | 3 |
| antioxidants⁵ | 2 |
| thixotrope⁶ | 2 |
| catalysts⁷ | 0.8 |
| adhesion promoter⁸ | 1.1 |
| skin enhancing additive⁹ | 1.0 |

¹OR110S from Kaneka Corporation
²CaCO3 and fumed SiO2
³MESAMOLL L235, Bayer Corporation
⁴MICROTHENE, Equistar Chemical Company
⁵1 wt % NAUGARD 445 and 1 wt % SANTOFLEX 134PD
⁶DISPARLON 6500
⁷dibutyltin dilaurate
⁸aminopropyl trimethoxysilanes
⁹0.5 wt % phenylmethyldiethoxysilane and 0.5 wt % vinyltrimethoxysilane

Example C, using phenylmethyldiethoxysilane and vinyl trimethoxysilane as skin enhancing additives had a skin over time of about 65 minutes. Example B illustrates that replacing the phenyltrimethoxysilane of Example 3 with the same amount of chemically similar phenylmethyldiethoxysilane does not provide a desirably improved skin over time.

A comparative silyl-functionalized poly(acrylate) composition using the following materials (Comparative Example D) was prepared using the procedure set out above. All percentages are rounded and by weight percent of total curable composition.

Comparative Example D

| material | wt % |
|---|---|
| silyl-functionalized poly(acrylate)component¹ | 42 |
| fillers² | 33 |
| Alkylsulfonic acid phenol and cresol esters | 14 |
| polyolefin⁴ | 3 |
| antioxidants⁵ | 2 |
| thixotrope⁶ | 2 |
| catalysts⁷ | 0.6 |
| adhesion promoter⁸ | 1.0 |
| skin enhancing additive⁹ | 2.0 |

¹OR110S from Kaneka Corporation
²CaCO3 and fumed SiO2
³MESAMOLL L235, Bayer Corporation
⁴MICROTHENE, Equistar Chemical Company
⁵1 wt % NAUGARD 445 and 1 wt % SANTOFLEX 134PD
⁶DISPARLON 6500
⁷dibutyltin dilaurate
⁸aminopropyl trimethoxysilanes
⁹1.0 wt % Bis(3-trimethoxysilylpropyl)-N-methyl amine and 1.0 wt % vinyltrimethoxysilane

Example D, using higher amounts of bis(3-trimethoxysilylpropyl)-N-methyl amine and vinyl trimethoxysilane as skin enhancing additives had a skin over time of about 40 minutes. However the composition was too slow to cure through the center to be commercially practical. Example D illustrates that replacing the phenyltrimethoxysilane of Example 3 with a greater amount of bis(3-trimethoxysilylpropyl)-N-methyl amine deleteriously changes the resulting composition properties.

While preferred embodiments have been set forth for purposes of illustration, the foregoing description should not be deemed a limitation of the disclosure herein. Accordingly, various modifications, adaptations and alternatives may occur to one skilled in the art without departing from the spirit and scope of the present disclosure.

What is claimed is:

1. A moisture curable composition, prepared from:
a (meth)acrylate component comprising a silyl-functionalized poly(acrylate);
a metal catalyst which is not dibutyltin dilaurate and an amine-based catalyst.

2. The composition of claim 1 wherein the amine-based catalyst is selected from 1,8-diazabicyclo[5.4.0]undec-7-ene (“DBU”), tetramethylguanidine (“TMG”) and 1,5-diazabicyclo[4.3.0]non-5-ene (“DBN”).

3. The composition of claim 1 which is only moisture curable.

4. The moisture curable composition of claim 1 further prepared from a skin enhancing additive.

5. The moisture curable composition of claim 1 further prepared from a skin enhancing additive selected from diphenyldimethoxysilane, phenyltrimethoxysilane, vinyltrimethoxysilane, methyltrimethoxysilane and ethyltrimethoxysilane.

6. The moisture curable composition of claim 1 wherein the silyl-functionalized poly(acrylate) has the structure 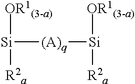
wherein each —O—R¹ is an independently selected hydrolyzable group; each R² is an independently selected C₁ to C₂₀ hydrocarbon radical; a is integer from 0-1, q is an integer from 2 to about 1,000, and A is a hydrocarbon diradical containing at least one (meth)acrylate linkage.

7. The composition of claim 1, further prepared from at least one of a phenylene diamine within structure I: 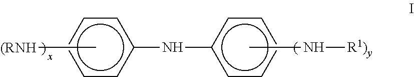
wherein R and R¹ are each members individually selected from the group consisting of C₁₋₁₂ alkyl, C₂₋₁₂ alkenyl, C₃₋₁₂ cyclo or bicycloalkyl, C₆₋₁₈ aryl, and derivatives thereof, and x and y are each individually 0-2;
a diphenyl amine within structure II: 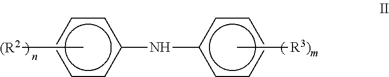
wherein R² and R³ are each members individually selected from the group consisting of C₁₋₁₂ alkyl, C₂₋₁₂ alkenyl, C₃₋₁₂ cyclo or bicycloalkyl, C₆₋₁₈ aryl, and derivatives thereof, and n and m are each individually 0-5; and combinations thereof.

8. The composition of claim 1, further prepared from a diluent embraced by the following structure: 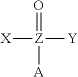
wherein Z is S or P, X and Y may be the same or different and may be hydroxy, alkyl, alkenyl, aryl, aralkyl, aralkenyl, alkoxy, alkenoxy and aryloxy and A is ═O, or alkoxy, alkenoxy or aryloxy.

9. The composition of claim 1, further prepared from filler selected from calcium carbonate, silica and combinations thereof.

10. The composition of claim 1, further prepared from a component which reduces shrinkage of the cured composition upon exposure of the cured composition to a hydrocarbon fluid, wherein the component is present in an amount sufficient to reduce shrinkage of the cured composition when exposed to a hydrocarbon fluid.

11. The composition of claim 1, further prepared from about 0.5 wt % to about 20 wt % by weight of the composition of a polyolefin component which reduces shrinkage of the cured composition upon exposure of the cured composition to a hydrocarbon fluid.

12. The composition of claim 1, further prepared from about 0.5 wt % to about 20 wt % by weight of the composition of a polyolefin component which reduces shrinkage of the cured composition upon exposure of the cured composition to a hydrocarbon fluid, wherein the polyolefin contains repeating units of at least one C₂ to C₇ alkene monomer.

13. Cured reaction products of the composition of claim 1.

14. Cured reaction products of the composition of claim 1 bonded to both of two spaced, predetermined sealing surfaces.

15. A gasket formed from cured reaction products of the composition of claim 1.

16. The composition of claim 1, further prepared from a skin enhancing additive; wherein the composition has a skin over time of less then about 40 minutes.

17. The composition of claim 1, further prepared from a skin enhancing additive selected from diphenyldimethoxysilane, phenyltrimethoxysilane, vinyltrimethoxysilane, methyltrimethoxysilane and ethyltrimethoxysilane; wherein the composition has a skin over time of less then about 40 minutes.

18. The moisture curable composition of claim 1 wherein the silyl-functionalized poly(acrylate) has the structure 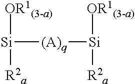
wherein each R¹ is an independently selected C₁ to C₄ hydrocarbon radical; each R² is an independently selected R² is C₁ to C₃ hydrocarbon radical; a is integer from 0-1, q is an integer from 2 to about 1,000, and A is a hydrocarbon diradical containing at least one (meth)acrylate linkage.

19. A moisture curable gasket composition comprising the moisture curable composition of claim 1.
